(19) United States
(12) Patent Application Publication
(10) Pub. No.: US 2022/0299631 A1
(43) Pub. Date: Sep. 22, 2022

(54) INSPECTION SYSTEM AND INSPECTION METHOD

(71) Applicant: NEC Corporation, Tokyo (JP)

(72) Inventors: Shinichi MORIMOTO, Tokyo (JP); Masanori SEKIDO, Tokyo (JP); Masaru ETO, Tokyo (JP); Tatsuya SUMIYA, Tokyo (JP); Shingo YAMANOUCHI, Tokyo (JP); Toshiyuki NOMURA, Tokyo (JP); Masayuki ARIYOSHI, Tokyo (JP)

(73) Assignee: NEC Corporation, Tokyo (JP)

(21) Appl. No.: 17/689,134

(22) Filed: Mar. 8, 2022

(30) Foreign Application Priority Data
Mar. 19, 2021 (JP) 2021-045898

(51) Int. Cl. G01S 13/88; G01S 7/41

(52) U.S. Cl. CPC G01S 13/887; G01S 7/412; G06V 40/10

(57) ABSTRACT

To shorten a waiting time for a belongings inspection, the present invention provides an inspection system 10 including an acquisition unit 11 that acquires target person identification information identifying an inspection target person, a determination unit 12 that determines, based on target person information stored in association with the target person identification information, reference data referred to in a belongings inspection for the inspection target person, an electromagnetic wave transmission/reception unit 14 that emits an electromagnetic wave having a wavelength of equal to or more than 30 micrometers and equal to or less than one meter and receives a reflection wave, and a detection unit 13 that executes, based on a signal of the reflection wave and the reference data, detection processing.

### TECHNICAL FIELD

The present invention relates to an inspection system and an inspection method.

### BACKGROUND ART

A technique related to the present invention is disclosed in Patent Document 1 (Japanese Patent Application Publication No. 2020-204513) and Patent Document 2 (Japanese Patent Application Publication No. 2019-106090).

Patent Document 1 discloses a technique for inspecting belongings by using an electrical wave having at least a wave of a wavelength falling between one millimeter to 30 millimeters, the technique detecting a suspicious person having a dangerous object, based on primary screening for roughly inspecting a large number of persons collectively and executing a detailed inspection, based on secondary screening for the detected suspicious person.

Patent Document 2 discloses a technique of including a plurality of types of defect discriminators such as a defect discriminator that detects a defect by focusing on dirt, a defect discriminator that detects a defect by focusing on a scratch, and the like, selecting a defect discriminator according to an attribute of a target object, and executing defect detection processing.

Patent Document 3 (Japanese Patent Application Publication No. 2004-126829) discloses a technique of identifying, based on an image of a visitor, a type of the visitor and determining entrance processing to be executed for each visitor according to the discriminated type. The entrance processing includes notification processing to a reception terminal, notification processing to a security terminal, and the like.

### DISCLOSURE OF THE INVENTION

In order to ensure security and the like, a belongings inspection is executed in various places. In a belongings inspection, shortening of a waiting time is expected.

An issue according to the present invention is to shorten a waiting time for a belongings inspection by using a non-conventional method.

According to the present invention,

provided is an inspection system including:

an acquisition means for acquiring target person identification information identifying an inspection target person;

a determination means for determining, based on target person information stored in association with the target person identification information, reference data referred to in an inspection for the inspection target person;

an electromagnetic wave transmission/reception means for emitting an electromagnetic wave having a wavelength of equal to or more than 30 micrometers and equal to or less than one meter, and receiving a reflection wave; and

a detection means for executing, based on a signal of the reflection wave and the reference data, detection processing.

Further, according to the present invention,

provided is an inspection method including:

by a computer,

acquiring target person identification information identifying an inspection target person;

determining, based on target person information stored in association with the target person identification information, reference data referred to in an inspection for the inspection target person;

emitting an electromagnetic wave having a wavelength of equal to or more than 30 micrometers and equal to or less than one meter, and receiving a reflection wave; and

executing, based on a signal of the reflection wave and the reference data, detection processing.

According to the present invention, a waiting time for a belongings inspection can be shortened.

### BRIEF DESCRIPTION OF THE DRAWINGS

FIG. 1 is a diagram illustrating a configuration example of an inspection system according to the present example embodiment.

FIG. 2 is a diagram illustrating one example of a hardware configuration of an apparatus according to the present example embodiment.

FIG. 3 is a diagram illustrating one example of a function block diagram of the inspection system according to the present example embodiment.

FIG. 4 is a diagram schematically illustrating one example of information processed by the inspection system according to the present example embodiment.

FIG. 5 is a diagram schematically illustrating one example of information processed by the inspection system according to the present example embodiment.

FIG. 6 is a diagram schematically illustrating one example of information processed by the inspection system according to the present example embodiment.

FIG. 7 is a diagram for illustrating one example of processing of determining a detection target object according to the inspection system of the present example embodiment.

FIG. 8 is a diagram for illustrating one example of processing of determining a detection target object according to the inspection system of the present example embodiment.

FIG. 9 is a diagram schematically illustrating one example of an electromagnetic wave transmission/reception unit according to the present example embodiment.

FIG. 10 is a flowchart illustrating one example of a flow of processing of the inspection system according to the present example embodiment.

FIG. 11 is a diagram illustrating one example of a function block diagram of the inspection system according to the present example embodiment.

FIG. 12 is a diagram schematically illustrating one example of information processed by the inspection system according to the present example embodiment.

FIG. 13 is a diagram schematically illustrating one example of information processed by the inspection system according to the present example embodiment.

FIG. 14 is a flowchart illustrating one example of a flow of processing of the inspection system according to the present example embodiment.

FIG. 15 is a configuration example of the inspection system according to the present example embodiment.

### DESCRIPTION OF EMBODIMENTS

Hereinafter, example embodiments according to the present invention are described by using the accompanying drawings. Note that, in all drawings, a similar component is assigned with a similar reference sign, and description thereof is omitted, as appropriate.

### First Example Embodiment

### “Outline”

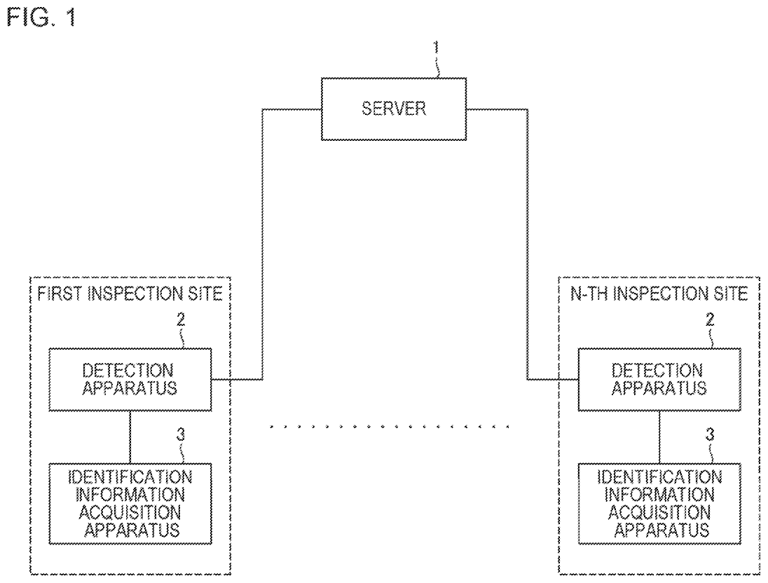

As illustrated in FIG. 1, an inspection system according to the present example embodiment includes a server 1, a plurality of detection apparatuses 2, and a plurality of identification information acquisition apparatuses 3. The plurality of detection apparatuses 2 and the plurality of identification information acquisition apparatuses 3 are installed in any facility requiring a belongings inspection. The facility includes, but not limited to, for example, a building, an office, an amusement facility, an airport, and a station. Note that, an installation location of the server 1 is not specifically limited

According to the present example embodiment, a plurality of inspection sites are placed in one facility, and at each inspection site, the detection apparatus 2 and the identification information acquisition apparatus 3 are installed. Then, a multistage belongings inspection is executed for a person coming to a facility at a plurality of inspection sites. It is conceivable that, for example, an inspection site is placed at an entrance of a facility and further an inspection site is placed at an entrance of each of plurality of areas present in the facility.

In this connection, in such a multistage belongings inspection, waste in that the same target object is handled, on an overlapping basis, as a detection target in belongings inspections at a plurality of inspection sites may occur. There is, for example, a case where a belongings inspection of a knife is executed at an inspection site placed at an entrance of a facility and thereafter a belongings inspection of a knife is executed again at another inspection site placed in the facility, and the like.

When an order of inspection sites through which a person passes is fixed, in view of the order, a target object to be detected in a belongings inspection at each inspection site is set, and thereby the waste described above is avoidable. However, when an order of inspection sites through which a person passes may be different with respect to each person, the means is not employable.

Therefore, the inspection system according to the present example embodiment associates a person coming to a facility with identification information for identifying the person differently from another person and registers a target object having been a detection target in a belongings inspection executed for each person, i.e., a target object having been subjected to detection processing. Then, the inspection system determines, based on the registration information, a target object to be detected in a belongings inspection at each inspection site with respect to each person. In other words, a target object to be detected in a belongings inspection at each inspection site is customized, with respect to each user, based on an inspection history so far.

According to the inspection system of the present example embodiment described above, waste in that the same target object is handled, on an overlapping basis, as a detection target unnecessarily in belongings inspections of a plurality of inspection sites can be reduced. As a result, a load on each inspection site is reduced, and a waiting time for a belongings inspection can be shortened.

### “Hardware Configuration”

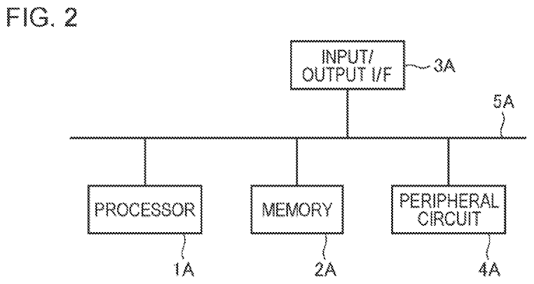

Next, one example of a hardware configuration of an inspection system 10 is described. FIG. 2 is a diagram illustrating a hardware configuration example of the inspection system 10. Each function unit included in the inspection system 10 is achieved by any combination of hardware and software, mainly including a central processing unit (CPU) of any computer, a memory, a program loaded on a memory, a storage unit (capable of storing, in addition to a program previously stored from a stage of shipping an apparatus, even a program downloaded from a storage medium such as a compact disc (CD), a server on the Internet, and the like) such as a hard disk storing the program, and an interface for network connection. Then, it is understandable to those of ordinary skill in the art that there are various modified examples with respect to an achievement method and an apparatus therefor.

As illustrated in FIG. 2, the inspection system 10 includes a processor 1A, a memory 2A, an input/output interface 3A, a peripheral circuit 4A, and a bus 5A. The peripheral circuit 4A includes various modules. The inspection system 10 may not necessarily include a peripheral circuit 4A. Note that, the inspection system 10 may be constituted of a plurality of apparatuses separated physically and/or logically. When the inspection system 10 is constituted of a plurality of apparatuses separated physically and/or logically, each of the plurality of apparatuses may include the hardware configuration described above.

The bus 5A is a data transmission path where the processor 1A, the memory 2A, the peripheral circuit 4A, and the input/output interface 3A mutually transmit/receive data. The processor 1A is an arithmetic processing apparatus, for example, such as a CPU and a graphics processing unit (GPU). The memory 2A is a memory, for example, such as a random access memory (RAM) and a read only memory (ROM). The input/output interface 3A includes an interface for acquiring information from an input apparatus, an external apparatus, an external server, an external sensor, an electromagnetic wave transmission/reception apparatus, and the like, an interface for outputting information to an output apparatus, an external apparatus, an external server, an electromagnetic wave transmission/reception apparatus, and the like, and the like. The input apparatus is, for example, a keyboard, a mouse, a microphone, and the like. The output apparatus is, for example, a display, a speaker, a printer, a mailer, and the like. The processor 1A issues an instruction to each module, and thereby can perform an arithmetic operation, based on an arithmetic operation result thereof

### “Function Configuration”

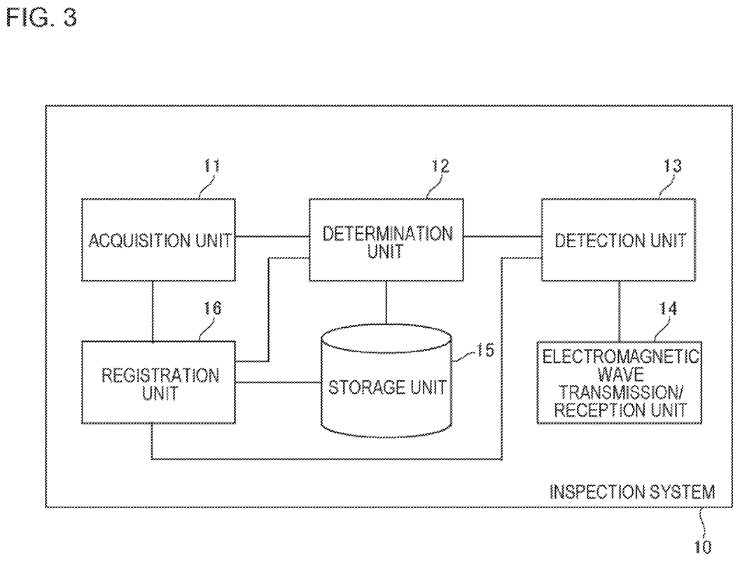

Next, a function configuration of the inspection system 10 is described. FIG. 3 illustrates one example of a function block diagram of the inspection system 10. As illustrated, the inspection system 10 includes an acquisition unit 11, a determination unit 12, a detection unit 13, an electromagnetic wave transmission/reception unit 14, a storage unit 15, and a registration unit 16.

These function units are included in any one of the server 1, the detection apparatus 2, and the identification information acquisition apparatus 3 in FIG. 1. There is no specific limitation to which one of the apparatuses includes each function unit, and therefore various patterns are employable. For example, the identification information acquisition apparatus 3 may include the acquisition unit 11, the detection apparatus 2 may include the electromagnetic wave transmission/reception unit 14, the server 1 may include the determination unit 12, the registration unit 16, and the storage unit 15, and the server 1 or the detection apparatus 2 may include the detection unit 13. Hereinafter, a configuration of each function unit is described.

The storage unit 15 stores target person information. The target person information is information associating target person identification information identifying persons (hereinafter, referred to as “inspection target persons”) coming to a facility differently from each other with an inspection history of each inspection target person.

Target person identification information may be information capable of identifying a plurality of persons differently from each other, and any technique is employable. The target person identification information may be characteristic information provided for each person, for example, such as face information (a face image, a feature value of an appearance extracted from a face image, or the like), fingerprint information, voiceprint information, iris information, and gait information. In addition, the target person identification information may be information generated for each person such as information in which numbers, characters, and the like are arranged, and the like.

An inspection history indicates a content of an inspection executed in a past period for each inspection target person at an inspection site placed in the facility. The inspection history indicates, for example, a target object having been a detection target in a belongings inspection executed for each inspection target person, i.e., a target object having been subjected to detection processing.

A “past period” may be a “current day”, may be a period “from a current time to a time before a predetermined time”, or may be such another period. For example, assuming a case where coming and going in/out of a facility are repeated, a period “from a last entrance timing to a facility to a current time” may be set as a “past period”.

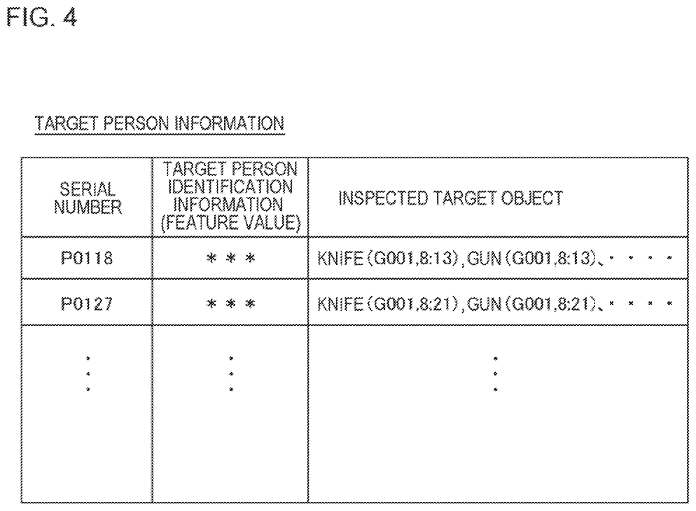

FIG. 4 schematically illustrates one example of target person information stored by the storage unit 15. In the illustrated example, a serial number, target person identification information, and an inspected target object are registered in association with one another. The serial number is identification information provided by the inspection system 10 to a person coming to a facility. The target person identification information is as described above. The inspected target object indicates a target object having being a detection target at a belongings inspection executed for each inspection target person in a past period. Note that, in the illustrated example, identification information (G001 and the like) of an inspection site where an inspection has been executed and a time (8:13 and the like) at which an inspection has been executed are registered in association with each inspected target object, but these pieces of information may not necessarily be registered and another piece of information may be further registered.

Note that, such target person information is registered by the registration unit 16 to be described below. Details of registration processing based on the registration unit 16 are described later.

When a return is made to FIG. 3, the acquisition unit 11 acquires, from an inspection target person coming to an inspection site, target person identification information identifying the inspection target person. The acquisition unit 11 acquires, before an inspection for an inspection target person is executed, target person identification information of the inspection target person. A configuration of the acquisition unit 11 depends on a configuration of target person identification information.

When, for example, target person identification information is face information, iris information, gait information, or the like, the acquisition unit 11 is configured by including an image-capture apparatus such as a camera. Further, when target person identification information is fingerprint information, the acquisition unit 11 is configured by including a fingerprint sensor (fingerprint reading apparatus). Further, when target person identification information is a voiceprint, the acquisition unit 11 is configured by including a microphone. Further, target person identification information is information in which a number, a character, and the like are arranged, the acquisition unit 11 is configured by including an input apparatus such as a near field communication device, a code reader, a touch panel, a keyboard, a physical button, a microphone, and a camera.

The determination unit 12 determines, based on target person information (see FIG. 4) stored in the storage unit 15, reference data referred to in a belongings inspection for an inspection target person. Specifically, the determination unit 12 determines, based on target person information, a detection target object to be detected in a belongings inspection with respect to each inspection target person. Then, the determination unit 12 determines, as reference data, data (a feature value of a shape, a reflection wave feature value, and the like) relating to the determined detection target object. Based on an inspection history in a past period of each inspection target person, a detection target object of each inspection target person is determined, and thereby a multistage belongings inspection based on a plurality of detection apparatuses 2 can be efficiently executed without waste.

While there are various algorithms for processing of determining, based on an inspection history in a past period of each inspection target person, a detection target object of each inspection target person, one example is described below.

### First Determination Example

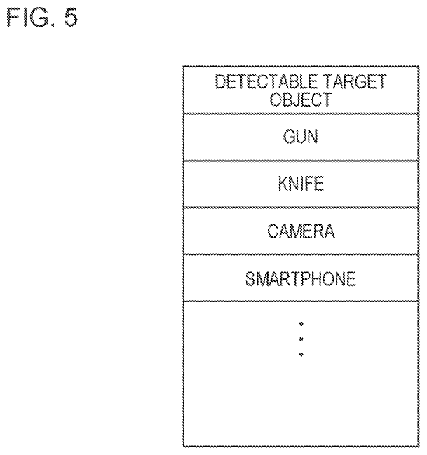

As illustrated in FIG. 5, a target object (hereinafter, referred to as a “detectable target object”) detectable by detection processing based on the detection apparatus 2 is stored in the storage unit 15. A target object in which a feature value collated in detection processing is registered is a detectable target object. In the present example, the determination unit 12 determines, as a detection target object, at least one of detectable target objects being not relevant to an inspected target object.

A detectable target object may be provided, for example, with a priority level. Then, the determination unit 12 may determine, as a detection target object, at least one of detectable target objects being not relevant to an inspected target object in descending order of a priority level.

The number of detection target objects determined at each inspection site may be previously determined. The number of detection target objects to be determined may be the same at all inspection site, or may be different with respect to each inspection site. Further, division into cases is executed based on a time and date, a day of week, weather, a temperature, a congestion situation (for example, recognized by an image acquired by image-capturing a facility) of each inspection site, a content of an event performed in a facility, and the like, and thereby the number of detection target objects determined at a time of being relevant to each case may be previously determined. Then, according to a situation (to what case the situation is relevant) of each timing, the number of detection target objects to be determined may be modified.

### Second Determination Example

In the present example, a target object (hereinafter, referred to as a “required target object”) to be detected in each of belongings inspections of a plurality of inspection sites is previously determined. In order to pass through each inspection site, it is required to confirm that a required target object determined for each inspection site is not carried.

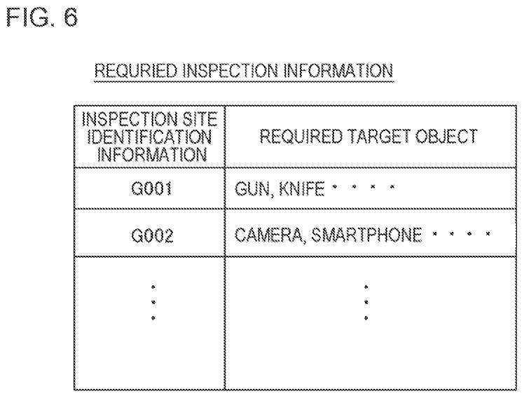

The storage unit 15 stores required inspection information indicating a required target object to be detected in each of belongings inspections of a plurality of inspection sites. FIG. 6 schematically illustrates one example of required inspection information. In the illustrated example, inspection site identification information and a required target object are associated with each other. Then, the determination unit 12 determines, as a detection target object, a required target object being not relevant to an inspected target object.

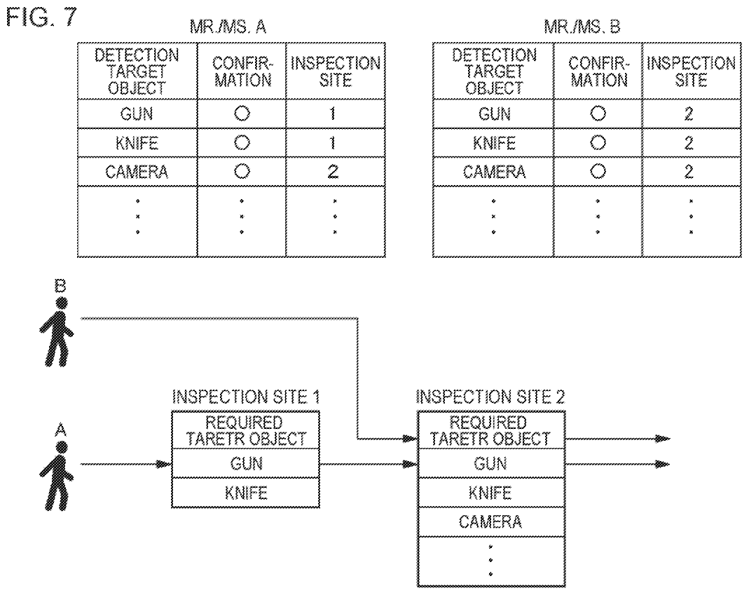

By using FIG. 7, a specific example is described. In the illustrated example, required target objects of an inspection site 1 include “a gun and a knife”, and required target objects of an inspection site 2 include “a gun, a knife, a camera, and the like”.

Mr./Ms. A passes through inspection sites in order of the inspection site 1 and the inspection site 2. When the inspection site 1 is passed, “a gun and a knife” being required target objects of the inspection site 1 are determined as detection target objects. And, when the inspection site 2 is passed, detection target objects eliminating “a gun and a knife” having been required target objects at the inspection site 1 among “a gun, a knife, a camera, and the like” being required target objects of the inspection site 2, i.e., “a camera and the like” are determined as detection target objects.

Mr./Ms. B passes through the inspection site 2 without passing through the inspection site 1. When the inspection site 2 is passed, “a gun, a knife, a camera, and the like” being required target objects of the inspection site 2 are determined as detection target objects.

### Third Determination Example

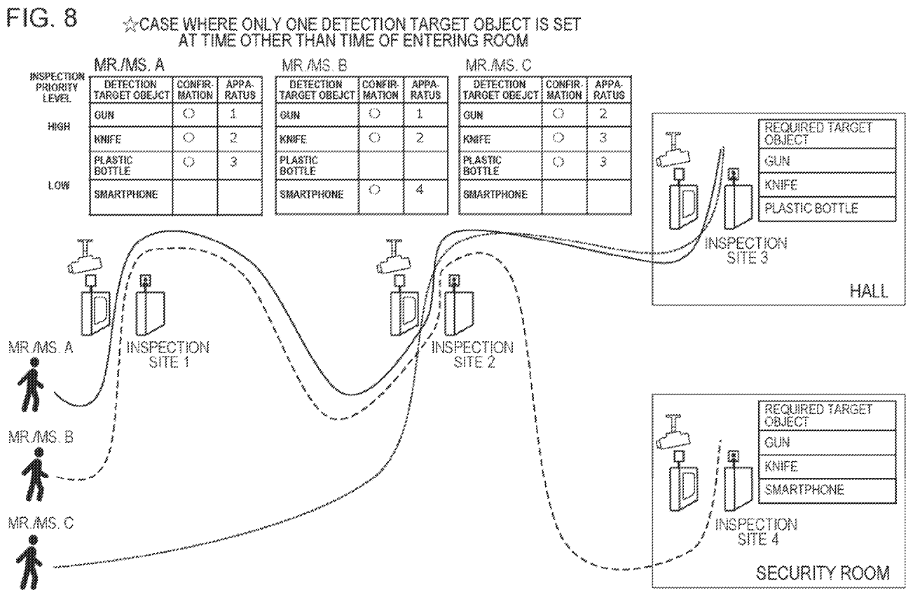

In the present example, the first determination example and the second determination example are combined. By using FIG. 8, a specific example is described. In the illustrated example, in either the inspection site 1 or the inspection site 2, a required target object is not set. Then, at the inspection site 1 and the inspection site 2, one detection target object is determined. A required target object of an inspection site 3 installed at an entrance of a hall includes “a gun, a knife, and a plastic bottle”, and a required target object of an inspection site 4 installed at an entrance of a security room includes “a gun, a knife, and a smartphone”.

Mr./Ms. A passes through inspection sites in order of the inspection site 1, the inspection site 2, and the inspection site 3. When the inspection site 1 is passed, “a gun” having a highest priority level among detectable target objects is determined as a detection target object. Then, when the inspection site 2 is passed, “a knife” having a highest priority level among detectable target objects being not relevant to an inspected target object is determined as a detection target object. Then, when the inspection site 3 is passed, “a plastic bottle” being not relevant to an inspected target object among “a gun, a knife, and a plastic bottle” being required target objects of the inspection site 3 is determined as a detection target object.

Mr./Ms. B passes through inspection sites in order of the inspection site 1, the inspection site 2, and the inspection site 4. When the inspection site 1 is passed, “a gun” having a highest priority level among detectable target objects is determined as a detection target object. Then, when the inspection site 2 is passed, “a knife” having a highest priority level among detectable target objects being not relevant to an inspected target object is determined as a detection target object. Then, when the inspection site 4 is passed, “a smartphone” being not relevant to an inspected target object among “a gun, a knife, and a smartphone” being required target objects of the inspection site 4 is determined as a detection target object.

Mr./Ms. C passes through inspection sites in order of the inspection site 2 and the inspection site 3. When the inspection site 2 is passed, “a gun” having a highest priority level among detectable target objects is determined as a detection target object. Then, when the inspection site 3 is passed, “a knife and a plastic bottle” being not relevant to an inspected target object among “a gun, a knife, and a plastic bottle” being required target objects of the inspection site 3 are determined as detection target objects.

Note that, so far, it has been assumed that a target object inspected once is handled as an inspected target object, but a target object inspected M times (M is an integer of equal to or more than 2) may be handled as an inspected target object. Further, a value of M may be different with respect to each target object. For a target object having a high priority level in detection, for example, such as a gun and a knife, a value of M is set to be large, and thereby repetitive inspections may be executed. And, for a target object having a low priority level in detection, a value of M is set to be small, and thereby overlaps of an inspection may be avoided.

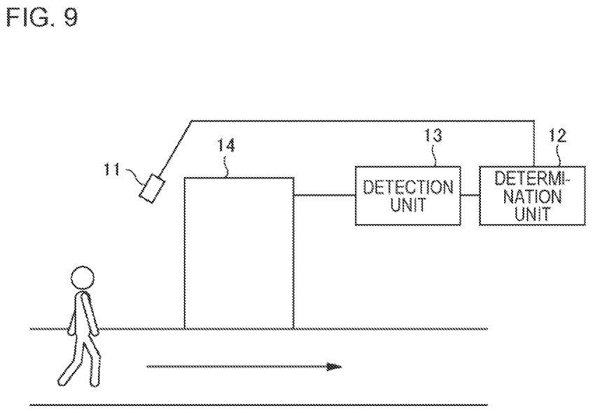

The electromagnetic wave transmission/reception unit 14 emits an electromagnetic wave (e.g., a microwave, a millimeter wave, a terahertz wave, and the like) having a wavelength of equal to or more than 30 micrometers and equal to or less than one meter toward an inspection target person present in a predetermined area, and receives a reflection wave. The electromagnetic wave transmission/reception unit 14 is, for example, a radar. The electromagnetic wave transmission/reception unit 14 can be configured by employing any technique. The electromagnetic wave transmission/reception unit 14 may be, as in an example of FIG. 9, for example, a sensor panel configured by including a radar arranged with a plurality of antenna elements. Note that, a panel is one example, and the electromagnetic wave transmission/reception unit 14 may be configured by using another method such as a gate through which an inspection target person passes, a booth which an inspection target person enters, and the like. The electromagnetic wave transmission/reception unit 14 is installed at each of a plurality of inspection sites.

The detection unit 13 determines, based on a signal of a reflection wave received by the electromagnetic wave transmission/reception unit 14, whether an inspection target person present in a predetermined area carries a detection target object determined by the determination unit 12. Hereinafter, one example of determination processing is described.

### First Processing Example

In the present example, the detection unit 13 generates a transmission image, based on a signal of a reflection wave received by the electromagnetic wave transmission/reception unit 14. Then, the detection unit 13 detects, based on a shape of an object appeared in the transmission image, a detection target object from the transmission image. The detection unit 13 determines, when a detection target object is detected from the transmission image, that an inspection target person present in a predetermined area carries the detected detection target object.

Based on a previous arrangement, a feature value of a shape of each of a plurality of objects is generated and the generated feature value is registered in the inspection system 10. An object in which a feature value of a shape is registered is the above-described “detectable target object”.

The detection unit 13 detects, based on a collation result between a feature value of a shape of a detection target object and a feature value of a shape appeared in a transmission image, a detection target object from the transmission image. Note that, an object being not set as a detection target object among detectable target objects is eliminated from a collation target. These pieces of processing based on the detection unit 13 may be achieved by using an estimation model generated by machine learning based on training data configured by including a transmission image and a label of each of a plurality of objects, or may be achieved based on template matching.

### Second Processing Example

In the present example, the detection unit 13 determines, based on a feature value (reflection wave feature value) appeared in a signal of a reflection wave received by the electromagnetic wave transmission/reception unit 14, whether an inspection target person present in a predetermined area carries a detection target object. The detection unit 13 determines, when a reflection wave feature value unique to a detection target object is detected from the signal of the reflection signal, that the inspection target person present in the predetermined area carries the detected detection target object.

Based on a previous arrangement, a reflection wave feature value of each of a plurality of objects is generated and the generated reflection wave feature value is registered in the inspection system 10. An object in which a reflection wave feature value is registered is the above-described “detectable target object”.

The detection unit 13 detects, based on a collation result between a reflection wave feature value of a detection target object and a feature value appeared in a signal of a reflection wave, a reflection wave feature value unique to a detection target object from the signal of the reflection wave. Note that, an object being not set as a detection target object among detectable target objects is eliminated from a collation target. These pieces of processing based on the detection unit 13 may be achieved by using an estimation model generated by machine learning based on training data configured by including a signal of a reflection wave and a label of each of a plurality of objects, or may be achieved based on template matching.

The detection unit 13 can output a detection result via a predetermined output apparatus (a display, a speaker, a warning lamp, a projection apparatus, or the like). The output apparatus may be installed, for example, at each inspection site and present predetermined information toward an inspection target person and a manager managing an inspection. Further, the detection unit 13 may cause an output pattern of an output apparatus to differ according to a content (whether a detection target object has been detected) of an inspection result. There are various output manners, and any means is employable according to the present example embodiment.

The registration unit 16 acquires target person identification information acquired by the acquisition unit 11. Further, the registration unit 16 acquires information indicating a detection target object determined by the determination unit 12. Then, the registration unit 16 registers, as an inspected target object, a detection target object determined by the determination unit 12 in target person information (see FIG. 4) in association with target person identification information of each inspection target person.

The registration unit 16 retrieves, for example, target person identification information acquired by the acquisition unit 11 from target person information (see FIG. 4). When the target person identification information is found, in association with the target person identification information, a detection target object determined by the determination unit 12 is newly registered as an inspected target object. On the other hand, when the target person identification information is not found, the registration unit 16 newly registers the target person identification information in target person information and registers, as an inspected target object, a detection target object determined by the determination unit 12 in association with the newly-registered target person identification information.

The registration unit 16 may further register a detection result (whether a detection target object has been detected) based on the detection unit 13 in association with target person identification information of each inspection target person. The information is stored by the storage unit 15.

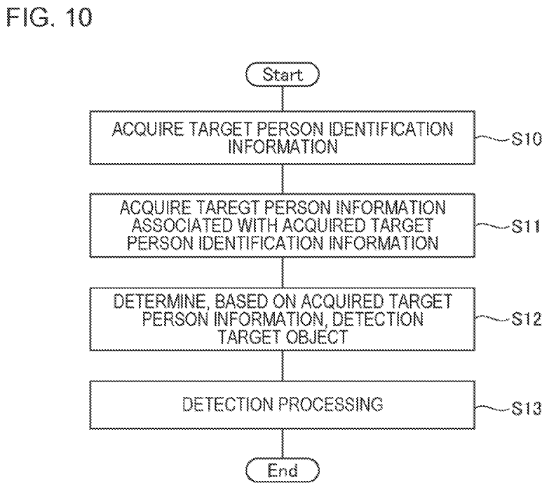

Next, by using a flowchart in FIG. 10, one example of a flow of processing of the inspection system 10 is described.

The inspection system 10 acquires, before a belongings inspection at an inspection site, target person identification information from an inspection target person (S10), and acquires target person information (see FIG. 4) associated with the acquired target person identification information (S11). The target person information indicates an inspection history of the target person in a past period. Then, the inspection system 10 determines, based on the acquired target person information, a detection target object to be detected in a belongings inspection for the inspection target person (S12). Thereafter, the inspection system 10 executes detection processing of detecting the determined detection target object (S13).

### Advantageous Effects

According to the inspection system 10 of the present example embodiment including a plurality of detection apparatuses 2 and being capable of determining a detection target object with respect to each detection apparatus 2, a distributed-type belongings inspection in which a detection target object is different with respect to each detection apparatus 2 is achieved. As a result, a load on each detection apparatus 2 is reduced, and thereby a waiting time for a belongings inspection in each detection apparatus 2 can be shortened.

Further, according to the inspection system 10 of the present example embodiment, in association with identification information identifying a person coming to a facility differently from another person, a target object having been a detection target in a belongings inspection executed for each person, i.e., a target object having been subjected to detection processing can be registered. Then, the inspection system 10 can determine, based on the registration information, with respect to each person, a target object to be detected in a belongings inspection at each inspection site. In other words, a target object to be detected in a belongings inspection at each inspection site can be customized, with respect to each user, based on an inspection history so far.

According to the inspection system 10 of the present example embodiment described above, waste in that the same target object is handled, on an overlapping basis, as a detection target unnecessarily in belongings inspections of a plurality of inspection sites can be reduced. As a result, a load on each inspection site is reduced, and a waiting time for a belongings inspection can be shortened.

### Second Example Embodiment

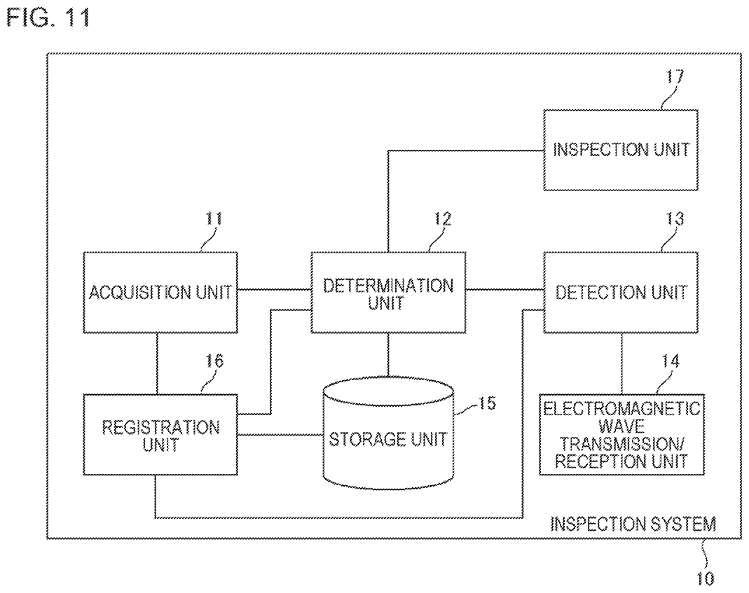

FIG. 11 illustrates one example of a function block diagram of an inspection system 10 according to the present example embodiment. The inspection system 10 according to the present example embodiment is different from the inspection system 10 according to the first example embodiment in that an inspection unit 17 is included.

The inspection unit 17 executes, for an inspection target person, an inspection other than a belongings inspection (hereinafter, referred to as a “belongings inspection based on a signal of a reflection wave”) based on a signal of a reflection wave of an electromagnetic wave having a wavelength of equal to or more than 30 micrometers and equal to or less than one meter described according to the first example embodiment. The inspection unit 17 can execute, for example, a body temperature inspection for measuring a body temperature of an inspection target person, a belongings inspection by using a metal detector, a belongings inspection by using an odor detector, and the like. These inspections can be achieved by employing any technique. The inspection unit 17 is installed at each of a plurality of inspection sites.

The inspection unit 17 can output an inspection result via a predetermined output apparatus (a display, a speaker, a warning lamp, a projection apparatus, or the like). The output apparatus may be installed, for example, at each inspection site and present predetermined information toward an inspection target person and a manager managing an inspection. Further, the inspection unit 17 may cause an output pattern of an output apparatus to differ according to a content of an inspection result. There are various output manners, and any means is employable according to the present example embodiment.

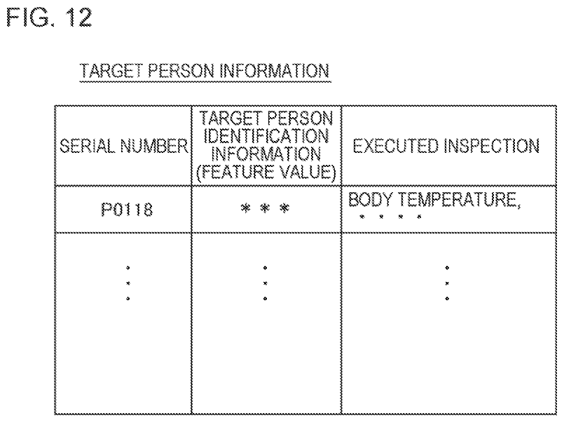

Target person information according to the present example embodiment indicates, as illustrated in FIG. 12, an inspection (hereinafter, referred to as an “executed inspection”) executed for each inspection target person in a past period. Note that, target person information according to the present example embodiment may further indicate, as described according to the first example embodiment, a target object having been subjected to detection processing in a belongings inspection based on a signal of a reflection wave (see FIG. 4).

Then, a determination unit 12 determines, based on target person information (see FIG. 12) stored in a storage unit 15, an inspection to be executed for an inspection target person. Based on an inspection history in a past period of each inspection target person, an inspection to be executed for each inspection target person is determined, and thereby a multistage inspection based on a plurality of inspection sites can be efficiently executed without waste.

While there are various algorithms for processing of determining, based on an inspection history in a past period of each inspection target person, a detection target object of each inspection target person, one example is described below.

### Fourth Determination Example

Information indicating an inspection (hereinafter, referred to as an “executable inspection”) executable by the inspection unit 17 is previously stored in the storage unit 15. The executable inspection is a belongings inspection based on a signal of a reflection wave, a body temperature inspection, a belongings inspection by using a metal detector, a belongings inspection by using an odor detector, and the like.

In the present example, the determination unit 12 determines, as an inspection to be executed, at least one of executable inspections being not relevant to an executed inspection.

An executable inspection may be provided, for example, with a priority level. Then, the determination unit 12 may determine, as an inspection to be executed, at least one of executable inspections being not relevant to an executed inspection in descending order of a priority level.

The number of inspections determined at each inspection site may be previously determined. The number of inspections to be determined may be the same at all inspection site, or may be different with respect to each inspection site. Further, division into cases is executed based on a time and date, a day of week, weather, a temperature, a congestion situation (for example, recognized by an image acquired by image-capturing a facility) of each inspection site, a content of an event performed in a facility, and the like, and thereby the number of inspections determined at a time of being relevant to each case may be previously determined. Then, according to a situation (to what case the situation is relevant) of each timing, the number of inspections to be determined may be modified.

### Fifth Determination Example

In the present example, an inspection (hereinafter, referred to as a “required inspection”) to be executed at each of a plurality of inspection sites is previously determined. In order to pass through each inspection site, it is required to pass a required inspection determined for each inspection site.

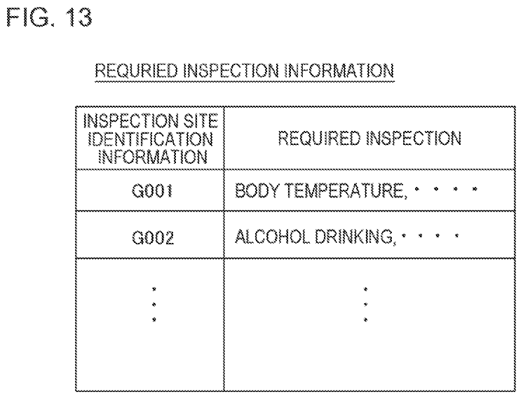

The storage unit 15 stores required inspection information indicating a required inspection to be executed at each of a plurality of inspection sites. FIG. 13 schematically illustrates one example of required inspection information. In the illustrated example, inspection site identification information and a required inspection are registered in association with each other. Then, the determination unit 12 determines, as an inspection to be executed. a required inspection being not relevant to an executed inspection.

### Sixth Determination Example

In the present example, the fourth determination example and the fifth determination example are combined.

Note that, an inspection executed once may be an executed inspection or an inspection executed M times (M is an integer of equal to or more than 2) may be handled as an executed inspection. Further, a value of M may be different with respect to each inspection. For an inspection having high necessity for repetitive executions, for example, such as a belongings inspection, a value of M is set to be large, and thereby repetitive inspections may be executed. And, for an inspection having low necessity for repetitive executions, such as a body temperature inspection, a value of M is set to be small, and thereby overlaps of an inspection may be avoided.

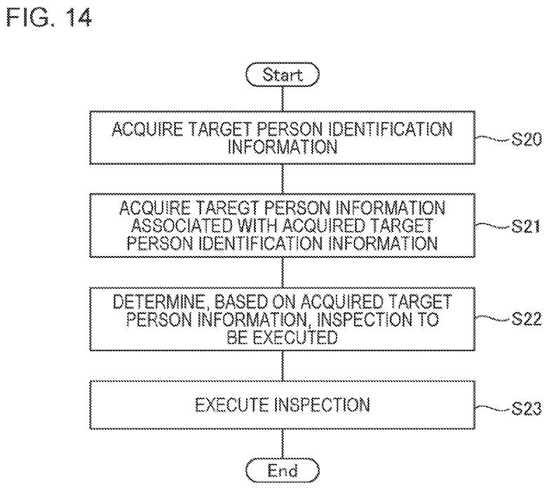

Next, by using a flowchart in FIG. 14, one example of a flow of processing of the inspection system 10 is described.

The inspection system 10 acquires, before an inspection at an inspection site, target person identification information from an inspection target person (S20), and acquires target person information (see FIG. 12) associated with the acquired target person identification information (S21). The target person information indicates an inspection history of the target person in a past period. Then, the inspection system 10 determines, based on the acquired target person information, an inspection to be executed for the inspection target person (S22). Note that, herein, when a belongings inspection based on a signal of a reflection wave is determined, the inspection system 10 may determine, based on processing described according to the first example embodiment, a detection target object to be detected in the belongings inspection. Thereafter, the inspection system 10 executes the determined inspection (S23).

Other configurations of the inspection system 10 according to the present example embodiment are similar to that of the first example embodiment.

According to the inspection system 10 of the present example embodiment, advantageous effects similar to the inspection system 10 according to the first example embodiment are achieved.

Further, according to the inspection system 10 of the present example embodiment, a distributed-type inspection in which an inspection content is different with respect to each inspection site is achieved. As a result, a load on each inspection site is reduced, and thereby a waiting time for an inspection at each inspection site can be shortened.

Further, according to the inspection system 10 of the present example embodiment, in association with identification information identifying a person coming to a facility differently from another person, an inspection having been executed for each person, i.e., an executed inspection can be registered. Then, the inspection system 10 can determine, based on the registration information, with respect to each person, an inspection to be executed at each inspection site. In other words, an inspection to be executed at each inspection site can be customized, with respect to each user, based on an inspection history so far.

According to the inspection system 10 of the present example embodiment described above, waste in that the same inspection is executed, on an overlapping basis, unnecessarily at a plurality of inspection sites can be reduced. As a result, a load on each inspection site is reduced, and a waiting time for an inspection can be shortened.

### MODIFIED EXAMPLES

Hereinafter, modified examples applicable to the first and second example embodiments are described. Also in these modified examples, advantageous effects similar to the first and second example embodiments are achieved.

### First Modified Example

In FIG. 1, target person identification information acquired by the identification information acquisition apparatus 3 is transmitted to the server 1 via the detection apparatus 2, but target person identification information acquired by the identification information acquisition apparatus 3 may be transmitted to the server 1 without passing through the detection apparatus 2. Further, an information collection apparatus that collects information of an inspection site may be installed at each inspection site. Then, both of a detection apparatus 2 and an identification information acquisition apparatus 3 may communicate with a server 1 via the information collection apparatus.

### Second Modified Example

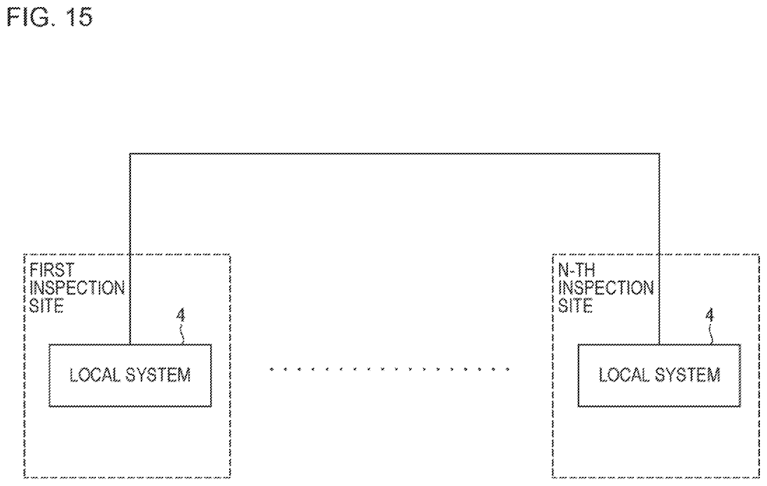

As illustrated in FIG. 15, an inspection system 10 may include, without the server 1, only a local system 4 installed at each of a plurality of inspection sites. In this case, each of local systems 4 installed at a plurality of inspection sites includes an acquisition unit 11, a determination unit 12, a detection unit 13, an electromagnetic wave transmission/reception unit 14, a storage unit 15, and a registration unit 16. The local system 4 may further include an inspection unit 17. Then, a plurality of local systems 4 communicate with each other and share information. Based on any synchronization processing, a content of target person information (see FIGS. 4 and 12) stored in each of a plurality of local systems 4 is the same.

### Third Modified Example

According to the example embodiments described above, reference data are a feature value (a feature value of a shape or a reflection wave feature value) of a detection target object. In other words, reference data are abnormal data inclusion of which is undesirable (data of a target object bringing-in of which is prohibited). Then, the detection unit 13 executes processing of detecting abnormal data determined as reference data from a signal of a reflection wave.

In the present modified example, reference data are normal data inclusion of which is desirable. The determination unit 12 determines, based on target person information, normal data to be referred to in an inspection for each inspection target person. Then, the detection unit 13 executes detection processing of detecting, based on the normal data, an abnormal state (a state different from a state indicated by normal data) from a signal of a reflection wave. Also in such a modified example, advantageous effects similar to the example embodiments described above are achieved.

### Fourth Modified Example

According to the example embodiments described above, a target object bringing-in of which is prohibited is set as a detection target object. In the present modified example, a target object necessary to be held by a user is set as a detection target object. For example, a badge of a police officer, an object obliged to be carried by a person participating in an event, or the like is a detection target object in the modified example. Then, in the modified example, a user whose detection target object is detected is allowed to pass, and a user whose detection target object is not detected is not allowed to pass.

Note that, a target object bringing-in of which is prohibited may be set as a first detection target object, and a target object necessary to be held by a user may be set as a second detection target object. In this case, detection results are divided into a plurality of cases such as “a case where a first detection target object is detected but a second detection target object is not detected”, “a case where a second detection target object is detected but a first detection target object is not detected”, “a case where both a first detection target object and a second detection target object are detected”, and “a case where neither a first detection target object nor a second detection target object is detected”. What processing is executed for a user at a time of each case is a design matter.

Note that, in the present specification, “acquisition” includes at least any one of a matter that “a local apparatus fetches data stored in another apparatus or a storage medium (active acquisition)”, based on user input or based on an instruction from a program, e.g., a matter that reception is executed by making a request or an inquiry to another apparatus, a matter that reading is executed by accessing to another apparatus or a storage medium, and the like, a matter that “data output from another apparatus are input to a local apparatus (passive acquisition)” based on user input or based on an instruction from a program, e.g., a matter that data distributed (or transmitted, notified on a push basis, or the like) are received and a matter that selective acquisition is executed from among received pieces of data or information, and a matter that “new data are generated by data editing (conversion to text, data rearrangement, partial data extraction, file-format modification, and like) and the new data are acquired”.

The whole or part of the example embodiments described above can be described as, but not limited to, the following supplementary notes.

1. An inspection system including:

an acquisition means for acquiring target person identification information identifying an inspection target person;

a determination means for determining, based on target person information stored in association with the target person identification information, reference data referred to in an inspection for the inspection target person;

an electromagnetic wave transmission/reception means for emitting an electromagnetic wave having a wavelength of equal to or more than 30 micrometers and equal to or less than one meter, and receiving a reflection wave; and

a detection means for executing, based on a signal of the reflection wave and the reference data, detection processing.

2. The inspection system according to supplementary note 1, wherein

the determination means determines a detection target object to be detected in a belongings inspection for the inspection target person, and determines, as the reference data, data relating to the detection target object, and

the detection means executes processing of detecting the detection target object as the detection processing.

3. The inspection system according to supplementary note 2, wherein

a plurality of the electromagnetic wave transmission/reception means each of which is installed at each of a plurality of inspection sites are provided, and the belongings inspection is executed at a plurality of inspection sites,

the target person information indicates an inspected target object being the detection target object in the belongings inspection executed in a past period for the inspection target person, and

the determination means determines, as the detection target object, a target object other than the inspected target object.

4. The inspection system according to supplementary note 3, wherein

the determination means
stores information indicating a required target object being a target object to be detected in each of the belongings inspections of a plurality of inspection sites, and
determines, as the detection target object, the required target object being not relevant to the inspected target object.
   5. The inspection system according to any one of supplementary notes 2 to 4, further including

a registration means for registering, as the inspected target object, the detection target object determined by the determination means in the target person information.

6. The inspection system according to supplementary note 5, wherein

the registration means registers a result of the detection processing in association with the target person identification information.

7. The inspection system according to any one of supplementary notes 2 to 6, further including

an inspection means for executing, for the inspection target person, an inspection other than the belongings inspection based on a signal of the reflection wave, wherein

the determination means determines, based on the target person information, an inspection to be executed for the inspection target person.

8. The inspection system according to supplementary note 7, wherein

a plurality of the inspection means each of which is installed at each of a plurality of inspection sites are provided, and an inspection other than the belongings inspection is executed at a plurality of inspection sites,

the target person information indicates an inspection executed in a past period, and

the determination means determines, as an inspection to be executed for the inspection target person, an inspection other than an inspection executed in the past period.

9. The inspection system according to supplementary note 8, wherein

the determination means
stores information indicating an inspection to be executed at each of a plurality of inspection sites, and
determines, as an inspection to be executed for the inspection target person, an inspection being not relevant to an inspection executed in the past period among the inspections to be executed.
   10. An inspection method including:

by a computer,

acquiring target person identification information identifying an inspection target person;

determining, based on target person information stored in association with the target person identification information, reference data referred to in an inspection for the inspection target person;

emitting an electromagnetic wave having a wavelength of equal to or more than 30 micrometers and equal to or less than one meter, and receiving a reflection wave; and

executing, based on a signal of the reflection wave and the reference data, detection processing.
1 Server
2 Detection apparatus
3 Identification information acquisition apparatus
4 Local system
10 Inspection system
11 Acquisition unit
12 Determination unit
13 Detection unit
14 Electromagnetic wave transmission/reception unit
15 Storage unit
16 Registration unit
17 Inspection unit
1A Processor
2A Memory
3A Input/output interface (I/F)
4A Peripheral circuit
5A Bus

1. An inspection system comprising:
at least one memory configured to store one or more instructions; and
at least one processor configured to execute the one or more instructions to:
acquire target person identification information identifying an inspection target person;
determine, based on target person information stored in association with the target person identification information, reference data referred to in an inspection for the inspection target person;
emit an electromagnetic wave having a wavelength of equal to or more than 30 micrometers and equal to or less than one meter, and receive a reflection wave; and
execute, based on a signal of the reflection wave and the reference data, detection processing.

2. The inspection system according to claim 1, wherein the processor is further configured to execute the one or more instructions to:
determine a detection target object to be detected in a belongings inspection for the inspection target person, and determines, as the reference data, data relating to the detection target object, and
execute processing of detecting the detection target object as the detection processing.

3. The inspection system according to claim 2,
wherein a plurality of the electromagnetic wave transmission/reception units are installed at a plurality of inspection sites, and the belongings inspection is executed at the plurality of inspection sites,
wherein the target person information indicates an inspected target object being the detection target object in the belongings inspection executed in a past period for the inspection target person, and
wherein the processor is further configured to execute the one or more instructions to determine, as the detection target object, a target object other than the inspected target object.

4. The inspection system according to claim 3, wherein the processor is further configured to execute the one or more instructions to:
store information indicating a required target object being a target object to be detected in each of the belongings inspections of a plurality of inspection sites, and
determine, as the detection target object, the required target object being not relevant to the inspected target object.

5. The inspection system according to claim 2,
wherein the processor is further configured to execute the one or more instructions to register, as the inspected target object, the determined detection target object in the target person information.

6. The inspection system according to claim 5, wherein the processor is further configured to execute the one or more instructions to register a result of the detection processing in association with the target person identification information.

7. The inspection system according to claim 2,
wherein the processor is further configured to execute the one or more instructions to:
execute, for the inspection target person, an inspection other than the belongings inspection based on a signal of the reflection wave, and
determine, based on the target person information, an inspection to be executed for the inspection target person.

8. The inspection system according to claim 7, wherein a plurality of the inspection units are installed at a plurality of inspection sites, and an inspection other than the belongings inspection is executed at the plurality of inspection sites,
wherein the target person information indicates an inspection executed in a past period, and
wherein the processor is further configured to execute the one or more instructions to determine, as an inspection to be executed for the inspection target person, an inspection other than an inspection executed in the past period.

9. The inspection system according to claim 8, wherein the processor is further configured to execute the one or more instructions to:
store information indicating an inspection to be executed at each of a plurality of inspection sites, and
determine, as an inspection to be executed for the inspection target person, an inspection being not relevant to an inspection executed in the past period among the inspections to be executed.

10. An inspection method comprising:
by a computer,
acquiring target person identification information identifying an inspection target person;
determining, based on target person information stored in association with the target person identification information, reference data referred to in an inspection for the inspection target person;
emitting an electromagnetic wave having a wavelength of equal to or more than 30 micrometers and equal to or less than one meter, and receiving a reflection wave; and
executing, based on a signal of the reflection wave and the reference data, detection processing.
